(19) United States
(12) Patent Application Publication
(10) Pub. No.: US 2005/0087955 A1
(43) Pub. Date: Apr. 28, 2005

(54) Trailer hitching aid

(76) Inventor: Charles Kellogg, Kuna, ID (US)

Correspondence Address: PEDERSEN & COMPANY, PLLC, P.O. BOX 2666, BOISE, ID, 83701, US

(21) Appl. No.: 10/933,821

(22) Filed: Sep. 2, 2004

Related U.S. Application Data
(60) Provisional application No. 60/499,654, filed on Sep. 2, 2003.

(51) Int. Cl. B60D 1/00

(52) U.S. Cl. 280/477

(57) ABSTRACT

A device for assisting the driver of a towing vehicle to align the vehicle's hitch with a trailer hitch without the assistance of another person or the need to exit the vehicle to check his progress. The hitching aid positioning system may be based on the distance between the vehicle bumper and vehicle hitch ball and the distance between the vehicle hitch ball and sight plane P directly behind the side rearview mirror and close to the side of the vehicle. The hitching aid also includes a guidance system that places a sight in front of a target plate directly in and sight plane P. When the vehicle is pointed in the proper direction, the sight will be centered on the target plate. The hitching aid, which preferably is entirely mechanical and preferably requires no electricity, detects the approach of the bumper with a trigger arm. When the user has backed up the vehicle parallel to sight plane P of the side rearview mirror, the vehicle hitch ball will be aligned with the trailer hitch socket. Also, at that point, the trigger arm releases a catch on the hitching aid and a signal flag is released to signal the driver to stop.

### FIELD OF THE INVENTION

This invention relates to the hitching of trailers to towing vehicles, and more particularly to visual aids for positioning towing vehicles relative to a trailer hitch.

### BACKGROUND OF THE INVENTION

Aligning a vehicle with a trailer hitch such that the towing ball is aligned with the trailer hitch can be a difficult process of trial and error, particularly when there is only one individual performing the task. Small trailers typically present no problem in coupling, because they can be manually positioned for hitching. However, large trailers or towed vehicles of substantial weight and size typically present problems in that it is often not possible to manually move the trailer, especially when elderly or smaller individuals attempt to do so.

In cases of large trailers or other towed vehicles, therefore, it is necessary to leave the socket propped up when disconnecting the coupling, and when the trailer is again ready for hauling, a towing vehicle is backed up to the trailer to place the ball portion of the hitch under the socket of the trailer hitch. However, the driver of a vehicle cannot see the ball or hitch while driving. If a second person is available to assist, the process is simplified. But if no assistance is available, the driver must repeatedly exit the vehicle to observe the relative locations of the ball and hitch before each movement of the towing vehicle. This can be a long and frustrating process.

A number of systems have been developed to attempt to simplify this process. For example, Hamilton (U.S. Pat. No. 2,984,011) discloses a two-part system. A device is attached to both the towing vehicle and the trailer to be towed. The devices extend past the sides of the vehicle. Electric lights are placed on the ends of the devices, and the driver aligns his vehicle by aligning the lights. When the ball and hitch are aligned, a switch is triggered to activate a light on the end of one of the devices to signal the driver to stop. Because of the lights, the devices must include batteries and/or be connected to the electrical circuitry of the towing vehicle.

Coleman (U.S. Pat. No. 4,627,634) discloses a two-part system. The first part is a sighting rod that attaches to the side of the vehicle. A target rod is placed upright on the ground and positioned to the side such that, if the vehicle and trailer are properly aligned, the sighting rod will contact the target rod. However, the vehicle must be positioned precisely in front of the trailer for the system to function properly, but no assistance for this is provided by the system.

Lockwood (U.S. Pat. No. 5,669,621) discloses another two-part system. A fixed sight member is magnetically attached to the back of the towing vehicle immediately behind the ball. A pivoting sight member is attached to the tongue of the trailer hitch. The sights are designed to be visible through the vehicle's rear window. Aligning the sights and backing up the towing vehicle up to bring the sights together positions the ball under the hitch. When the towing vehicle reaches this position, the pivoting sight member is actuated signaling the driver to stop. However, it is not always possible to see out the rear of the towing vehicle; some vehicles do not have rear windows or the view may be obstructed by objects stowed in the vehicle.

Thus, there continues to be a need for a simple system that adapts to all or substantially all vehicles and trailers or other towed vehicles and that effectively helps the driver align and position the vehicle. There is a need for a system that does not require connecting to either vehicle or trailer.

### SUMMARY OF THE INVENTION

The present invention comprises a hitching aid that is placed a predetermined distance from a trailer or other towed object. The hitching aid is visible to a driver of a towing vehicle so that the driver may back up toward the towed object, with the hitching aid as the visual reference point for the driver, and, when the towing vehicle nears a position wherein hitching between the towing vehicle and the towed object may be accomplished, the vehicle contacts a portion of the hitching aid and trips or otherwise actuates a signal to the driver.

Embodiments of the hitching aid may be used according to invented methods, preferably by predetermining one or more dimensions of the towing vehicle and then placing the hitching aid relative to the towed vehicle using those predetermined dimensions. The predetermined dimensions preferably include the approximate distance (D1) from the vertical plane extending through the driver's line of sight to the vertical plane that extends through the towing vehicle's hitch and that is parallel to the line of sight plane. Also, the predetermined dimensions of the towing vehicle preferably include the distance (D2) from the towing vehicle hitch to the towing vehicle bumper. With these two distances known, the preferred hitching aid may be placed relative to the towed object in a position generally corresponding to distance D1 to the side of the towed vehicle hitch and distance D2 longitudinally generally in front of the vehicle hitch. This way, when the driver targets the preferred hitching aid in his mirror as he backs up, the bumper will trip/actuate the hitching aid's signal when the vehicle's hitch is perfectly or nearly perfectly aligned with and near the towed object hitch. Measurements and reference points other than the preferred D1 and D2 may be used, as long as the procedures are kept consistent throughout the steps of measuring, hitching aid placement relative to the towed vehicle, and targeting of the hitching aid to the point at which the towed vehicle may be easily hitched the towing vehicle.

### BRIEF DESCRIPTION OF THE DRAWINGS

FIG. 1A is an exploded view of the one embodiment of the invented trailer hitching aid stand, with dashed lines U and S illustrating positioning of parts of the stand for use, and for storage, respectively.

FIG. 1B is a perspective view of the embodiment of FIG. 1A assembled for use, with the stop signal in the up (back-up) position.

FIG. 1C is a perspective view of the embodiment of FIGS. 1A and 1B with the stop signal in the down (stop) position.

FIG. 2A is a top view illustrating the measuring stick of the embodiment of FIG. 1A being used to determine the distance between the bumper and hitch ball of the towing vehicle, and the measuring rope being used to determine the distance between the towing vehicle hitch ball and the plane of sight close to the side of the towing vehicle.

FIG. 2B is a top view of the embodiment of FIG. 2A illustrating the stand being positioned relative to the towed vehicle via the measuring stick and positioning rope that have been marked or adjusted to indicate the distances measured in FIG. 2A.

FIG. 2C is a perspective view of the one embodiment of an adjustment system for adjustably attaching the measuring stick to the measuring rope, and, thus, to “lengthen” or “shorten” the measuring rope of FIGS. 2A and 2B to match the distance between the towing vehicle hitch ball and the plane of sight in FIG. 2A.

FIGS. 2D and 2E illustrate the stand embodiment of FIGS. 1-2B in use in circumstances wherein the vehicle cannot be backed up straight to the trailer, but rather must be backed up with its longitudinal axis at an angle to the longitudinal axis of the trailer, but wherein the hitching aid and its previous stick and rope measurements may still be used.

FIG. 3A is a top view of the embodiment of FIG. 1-2B in use, wherein the driver is backing up the towing vehicle by watching the stand via the left mirror, and the bumper of the towing vehicle is first contacting the trigger arm.

FIG. 3B is a top view of the embodiment of FIG. 3A in use, wherein the driver has further backed-up the towing vehicle and the bumper of the towing vehicle is pushing and moving the trigger arm, but not to the extent that the trigger arm has actuated the stop signal.

FIG. 3C is a top view of the embodiment of FIGS. 3A and 3B in use, wherein the driver has further backed-up the towing vehicle to the point where the bumper of the towing vehicle has pushed the trigger arm to an extent that actuates the stop signal.

### DETAILED DESCRIPTION OF THE INVENTION

Referring to the figures, there are shown several, but not the only, embodiments of the invented trailer hitching aid and methods. While the inventor envisions that the invented trailer hitching aid and methods will work with any type of hitching means, the aid and methods are illustrated in the drawings in use with a ball-and-socket-type hitch as this is the most commonly encountered trailer hitch.

While the term “trailer” is used herein in many instances, it is to be understood that the invented apparatus and methods may be used with many different towed objects/vehicles. For example, hitching of a boat trailer, a recreational trailer, an enclosed utility trailer, and many other objects may be aided by embodiments of the invention.

The preferred embodiments of the hitching aid stand work comprise systems that do not attach any structure to the towing vehicle or to the towed vehicle, and that are usable in most, if not all, hitching situations. The invented stand and methods allow the user to predetermine features of his towing vehicle, and, therefore, to predetermine some of the dynamics of the hitching process, specifically, where the towing vehicle must be positioned to properly hitch to the towed vehicle. The invented system predetermines these features of the towing vehicle and then uses these features to place an embodiment of the invented stand relative to the towed vehicle, so that the driver may thereafter use the invented stand as the reference point during the backing-up/hitching process, rather than using the towed vehicle/object as the reference point. This is especially beneficial in the many instances wherein the towed vehicle/object is not visible to the driver of the towing vehicle from the driver's seat, as discussed above in the Background Section.

The features of the towing vehicle that are predetermined preferably include: 1) the distance (D1) from the vehicle hitch to the driver's line of sight (for example, when he/she is in the driver's seat and looking rearwards using the side-view mirror), which is typically within about 1-3 inches of the side of the towing vehicle, and 2) the distance (D2) from the towing vehicle hitch to the towing vehicle bumper. With these two distances known by measurement, the stand may be placed to the side of the towed object a distance generally equal to D1, and generally forward from the towed object a distance generally equal to D2. This way, the preferred stand is positioned so that, when the driver visually “targets” the stand in his mirror as he backs up the towing vehicle, the bumper will trip/actuate the stand's signal when the vehicle's hitch is exactly or very nearly aligned with and near the towed object hitch. The tripping/actuating of the stand's signal serves to preferably visually signal the driver, so that he/she knows to stop the towing vehicle because the towing vehicle hitch member (typically a ball) is in proper position for hitching relative to the towed vehicle hitch member (typically a socket).

One method of using the invented hitching aid stand is to position the towing vehicle in front of the towed vehicle a convenient distance (typically much greater than D2), for example, by backing-up the vehicle into the entry of a driveway or to within 20-40 feet of the towed vehicle. Preferably, the longitudinal axis of the towing vehicle is roughly aligned with the longitudinal axis of the towed vehicle. After proper placement of the hitching aid stand, the driver may then back up the towing vehicle the rest of the way, using the hitching aid stand as described herein, to the point of being within a few inches or preferably less of a “perfect” hitch position. It is important to note, however, that the stand, and methods of using the stand, do not require that the towing vehicle be exactly in front of or even roughly aligned with the longitudinal axis of the towed vehicle.

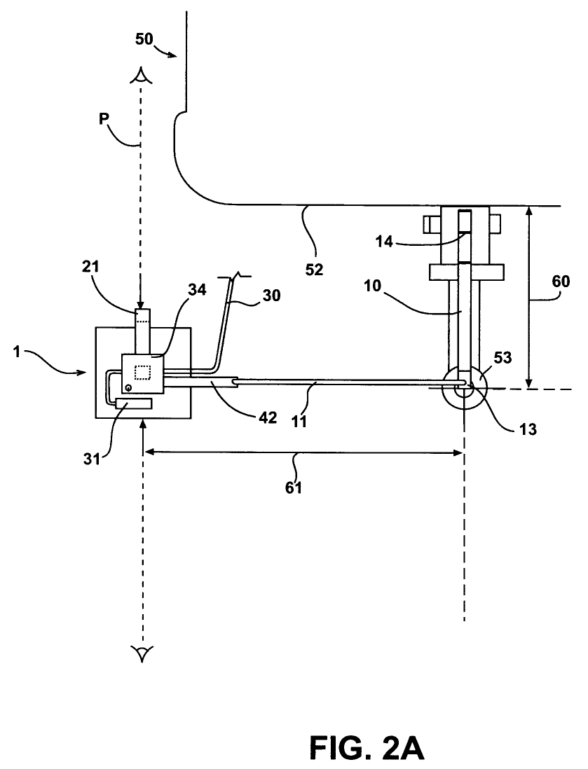

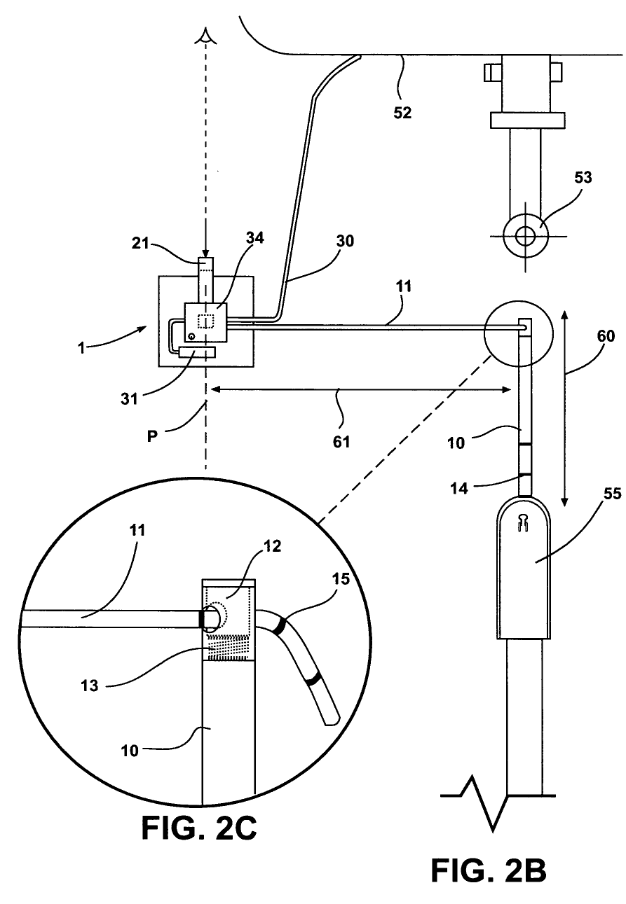

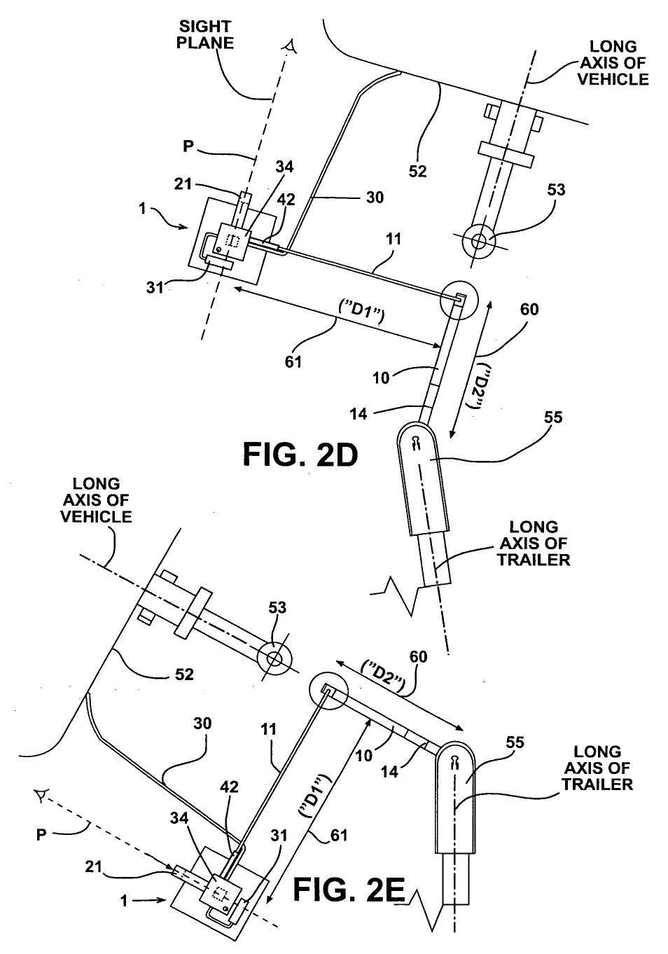

As illustrated in FIGS. 2D and 2E, however, the towing vehicle may approach the towed vehicle at a significant angle to the longitudinal of the towed vehicle. To account for this, the user will place the stand in a position that is D2 from the center of the hitch socket toward the towing vehicle (which has been backed up at least into the general vicinity of the towed vehicle) and D1 transversely to the side of the line between the hitch socket and the vehicle. This approach is very similar to the approach used if the towing vehicle longitudinal axis is aligned with the longitudinal axis of the towed vehicle, except that: D2 is generally parallel to the towing vehicle longitudinal axis but not parallel to the towed vehicle longitudinal axis, and D1 is transverse (perpendicular) to the towing vehicle longitudinal axis but not transverse to the towed vehicle longitudinal axis. Thus, one may describe embodiments of the invented hitching aid stand as being placed relative to the trailer or other towed vehicle in a position having coordinates relative to the trailer hitch that may correspond to D1 generally to the side of the hitch and D2 generally forward from the hitch.

Preferably, the hitching stand comprises one or more measurement devices, both for determining D1 and D2 and for subsequently properly placing the stand relative to the towed object. Preferably, the hitching stand has a target system to visually aid the driver in backing up, and a signal system to visually alert the driver that he should stop. Although audio and/or light systems may be added to some embodiments for signaling the driver, the preferred embodiments of the hitching stand do not have electrical or electronic parts. Also, while some embodiments of the invented hitching stand may include components that may connect to or be mounted onto the towing or towed vehicles, the preferred embodiments do not include components connecting to or mounting onto the vehicle or towed object. Embodiments of the invented stand may be stored on either the towing or towed vehicle or object.

The preferred embodiment shown in the Figures is intended to allow a single person to easily couple a towing vehicle to a trailer. It preferably comprises a single unit including a system for positioning the hitching aid relative to the trailer based on the dimensions of the towing vehicle. Said system preferably is easily adjusted to accommodate any of the many towing vehicles available to users. The preferred hitching aid stand also includes a system that indicates to the driver whether the towing vehicle is approaching the trailer at the proper angle, and what correction is required if the vehicle is not properly aligned with the trailer. Finally, the preferred hitching aid includes a system that detects the approach of the towing vehicle, preferably without any expensive electronic sensors, and signals the driver to stop when the vehicle is properly positioned for coupling.

In use, the preferred embodiment of the invented system is positioned to one side of the trailer so that it is within the line of sight in the driver's side mirror when the towing vehicle is properly aligned with the stand and, therefore, with the towed object. The hitching aid is positioned based on the distance from the center of the vehicle hitch ball to the line of sight of the driver (at generally the center of the rearview mirror), and the distance from the vertical plane of the bumper rear surface to the vertical plane passing through the ball. Since these distances vary over the wide variety of towing vehicles available, the positioning system is preferably adjustable to any vehicle. Once these distances have been measured by the measuring device(s), they may be marked or recorded so that the hitching aid stand can be reset to those dimensions if they are subsequently changed for use with a different towing vehicle.

In generally, the preferred stand extends upwards from a base on the ground. A trigger arm extends generally forward and downward from the stand such that the towing vehicle's bumper will contact it when backing up to the trailer. The trigger arm, when moved by the bumper, contacts a signal catch. The signal catch holds a stop signal in a down position that is, preferably, not readily visible to the driver. The trigger arm contacting the signal catch causes the signal catch to disengage from the spring-loaded stop signal, allowing it to move to the up position, which is readily visible to the driver.

The hitching aid stand keeps the vehicle properly aligned to the trailer using a back plate and sight. The back plate is positioned a short distance behind the sight. If the towing vehicle is properly aligned, the sight appears to be centered on the back plate when viewed from the driver's perspective. If the vehicle veers to the left or right or is approaching the trailer from the wrong angle, the sight and back plate will not be aligned. The necessary correction is apparent from the relative positions of the sight and back plate.

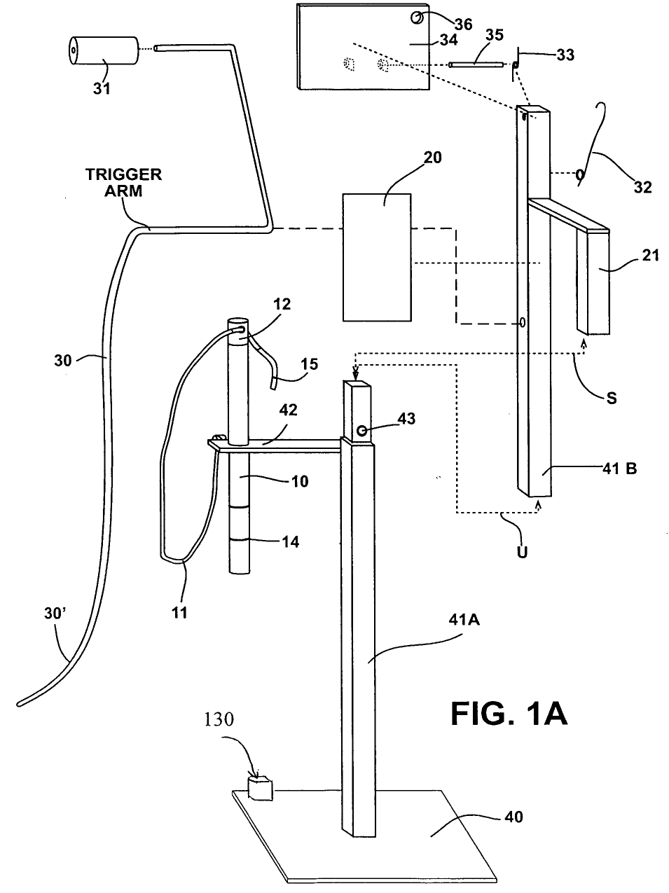

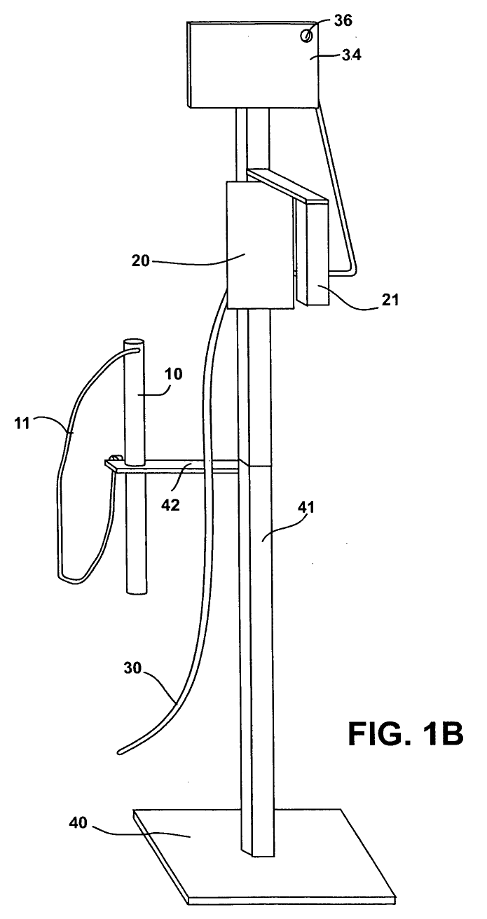

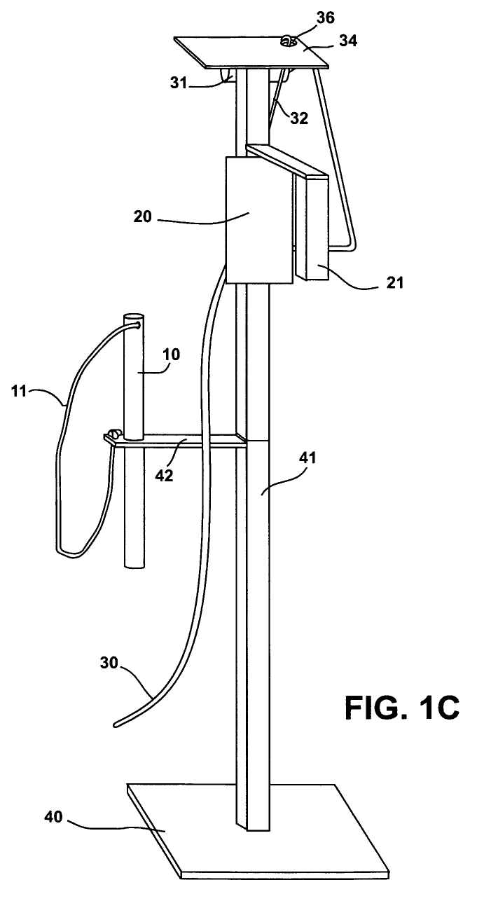

Referring to FIGS. 1A, 1B, and 1C, the preferred embodiment is shown standing alone. FIG. 1A shows the components separately and illustrates how hitching aid 1 may be configured for storage and transportation (line S). FIGS. 1B and 1C show the preferred embodiment assembled for use (see line U). The preferred embodiment comprises base 40, support 41, trigger arm 30, signal catch 32, signal spring 33, stop signal 34, target plate 20, sight 21, measuring stick 10, and measuring rope 11. Preferably, rope clamp 12 with spring 13 is included with measuring rope 11 and trigger arm 30 includes trigger roller 31. In the preferred embodiment, support 41 comprises two pieces 41a and 41b that are separable so that hitching aid 1 may be broken down for storage or transportation. For storage, support 41b may be attached to sight 21, as illustrated by dotted lines S in FIG. 1A, to make hitching aid 1 shorter. For use, support 41b is attached to support 41a, forming support 41, as illustrated by dotted lines U in FIG. 1A. Optionally, support 41b (during use) and sight 21 (during storage) are held in place on support 41a by spring-loaded ball 43.

Support 41 extends upwards from base 40, and supports the other elements of the preferred embodiment. A spring-loaded stop signal 34 is located at the top of support 40, and is pivotally attached thereto via axle 35. As illustrated in FIG. 1B, signal spring 33 biases stop signal 34 so that its face is generally perpendicular to base 40—the “up position.” Stop signal 34 may be pivoted so that its face is generally parallel to base 40—the “down position”—as shown in FIG. 1C. A catch hole 36 is provided in stop signal 34 so that signal catch 32 may be passed through catch hole 36 and hold stop signal 34 in the down position. Signal catch 32 is pivotally connected to support 41. Trigger arm 30 passes through support 40 via hole 44. The top end of trigger arm 30 is parallel to base 40 is preferably covered by trigger roller 31, which is capable of rotating around its axis—i.e., the top end of trigger arm 30. Trigger arm 30 pivots around the point where it passes through support 41 such that trigger roller 31 can abut into signal catch 32, pushing it forward to cause it to release stop signal 34, which results in signal spring 33 biasing stop signal 34 to move from its down position to its up position. Trigger arm 30 is configured so that this occurs when the bottom end of said trigger arm is directly to the side of support 41, that is, when the towing vehicle has pushed the bottom portion 30′ to about the transverse plane of support 41. Also, trigger arm 30 is preferably balanced so that, in its equilibrium position—the position where trigger arm 30 rests if no other object, such as bumper 53, is applying any force to it—trigger roller 31 does not contact signal catch 32. In the preferred embodiment, trigger roller 31 serves as both a weight positioned on the rear end of trigger arm 30 to achieve optimal balance for trigger arm 30, and as the portion of the trigger arm that impacts the signal catch 32. Alternatively, other types of weights may be used or the proper weighting may result from the inherent weight and size of the portions of the trigger arm. Further, the weight need not necessarily be movable relative to the trigger arm, but may be fixed to the arm or integral with the arm. Also, the portion of the trigger arm that contacts the signal catch 32 need not be weighted, need not be moveable relative to the rest of the trigger arm, and need not even be enlarged relative to the rest of the trigger arm.

Target plate 20 is attached to support 41 perpendicularly to base 40 and parallel to stop signal 34—when in its up position. Sight 21 is positioned directly in front of target plate 20, and has a different color—preferably, the colors of target plate 20 and sight 21 are highly contrasting. Target plate 20 and sight 21 are preferably located near the top of support 41 so as to be easily seen during use.

Measuring rope 11 is attached to support 41, in the preferred embodiment, via arm 42. Alternatively, measuring rope could be attached directly to support 41. However, arm 42 is preferred because it improves the hitching aid's positioning system, as described below, and because hole 45 provides a convenient place to store measuring stick 10. Measuring rope 11 passes through measuring stick 10 via rope clamp 12. Preferably, clamp 12 is spring-biased to tightly grip measuring rope 11. Optionally, other clamps could be used or measuring rope could be knotted at the appropriate length. The advantages of the arrangement of these elements are better understood in light of their functions, as described below.

Referring now to FIGS. 2A, 2B, and 2C, the invented hitching aid 1 is calibrated to the towing vehicle 50 to be used, so that it can be properly positioned relative to trailer hitch 55. As shown in FIG. 2A, measuring stick 10 is used to determine the longitudinal distance 60 from the rear surface of bumper 52 to the center of hitch ball 53 (elsewhere also designated D2). Measuring stick 10 may be longer than the distance being measured. The user may cut measuring stick 10 down to match the measured distance, or may place a mark 14 on measuring stick 10 at an appropriate point so that the distance is indicated thereon. Alternatively, longitudinal distance 60 could be measured with different reference points—e.g., the front or back edge of hitch ball 53, as long as the procedure is kept consistent throughout the measuring, stand placement, and hitching process.

Also shown in FIG. 2A, measuring rope 11 is used to determine the transverse distance 61 from the center of the hitch ball 52 to sight plane P, which is the vertical plane generally parallel to, and spaced a few inches from, the left side of the towing vehicle (also called herein D1). The driver, while backing up the vehicle, will look in side rearview mirror 51 back along the side of the vehicle at hitching aid 1 to judge how to back up the vehicle. Sight plane P is typically about 2-4 inches from the plane of the vehicle side. Thus, measuring rope 11 may be used to determine the longitudinal distance 60 from hitching aid 1 to the center of hitch ball 53. This is accomplished by adjusting the effective length of measuring rope 11—e.g., by adjusting the position of measuring stick 10 on measuring rope 11 with clamp 12—so that measuring stick 10 is lined up with the center of hitch ball 53, with measuring rope 11 pulled taut. Marks 15 may also be placed on measuring rope 11 so that clamp 12 may be adjusted for different vehicles without requiring re-measuring every time the system must be recalibrated. FIG. 2C shows a one of many possible devices, spring-loaded clamp 12, for adjustably connecting the stick 10 to the rope 11 and fixing the connection between measuring stick 10 and measuring rope 11. It also illustrates how mark 15 may be placed on measuring rope 11.

Preferably, measuring rope 11 is attached to hitching aid 1 via arm 42 because the user can quickly and easily check whether the hitching aid is properly aligned by looking down the length of measuring rope 11 to see whether it is parallel to arm 42. Also, pulling lightly on measuring rope 11 may be sufficient to properly align hitching aid 1.

In use of hitching aid 1, one may see how hitching aid 1 is positioned in FIG. 2B. Hitching aid 1 is placed relative to the trailer hitching ball (or other reference point determined to be appropriate according to the general measuring procedures illustrated by the above example) using the longitudinal and transverse measurements previously determined. Measuring stick 10 is used to position hitching aid 1 forward of hitch socket 55 a longitudinal distance 60 equal to the distance from bumper 52 to the center of hitch ball 53. Measuring rope 11 is used to place hitching aid 1 the proper transverse distance 61 from hitch socket 55 so that sight 21 and 20 will be properly aligned in the driver's side rearview mirror when hitch ball 53 is lined up with hitch socket 55. Before use, stop signal 34 is moved into its down position and held there by hooking signal catch 32 in catch hole 36.

As discussed above, measuring rope 11 and arm 42 may be used during set-up of the hitching aid at the side of the trailer to ensure that the stand is facing the proper direction, that is, with the target plate perpendicular to the sight plane. The user can quickly and easily check whether the hitching aid is properly aligned by properly positioning the stick 10 relative to the trailer hitch socket, and positioning the stand out from the stick with arm 42 and rope 11 is a straight line. Also, pulling lightly on measuring rope 11 may be sufficient to properly align hitching aid 1 (as the stand's base will swivel on the ground).

As one will note in FIGS. 2D and 2E and as discussed above, the vehicle does not need to be aligned with its longitudinal axis parallel with the trailer's longitudinal axis, as long as the stand is set up with the target plate perpendicular to the vehicle's longitudinal axis. This way, if the vehicle is backing up to the trailer from an angle, for example, to avoid an obstacle or due to the parked position of the trailer, the hitching aid 1 and methods will still work effectively.

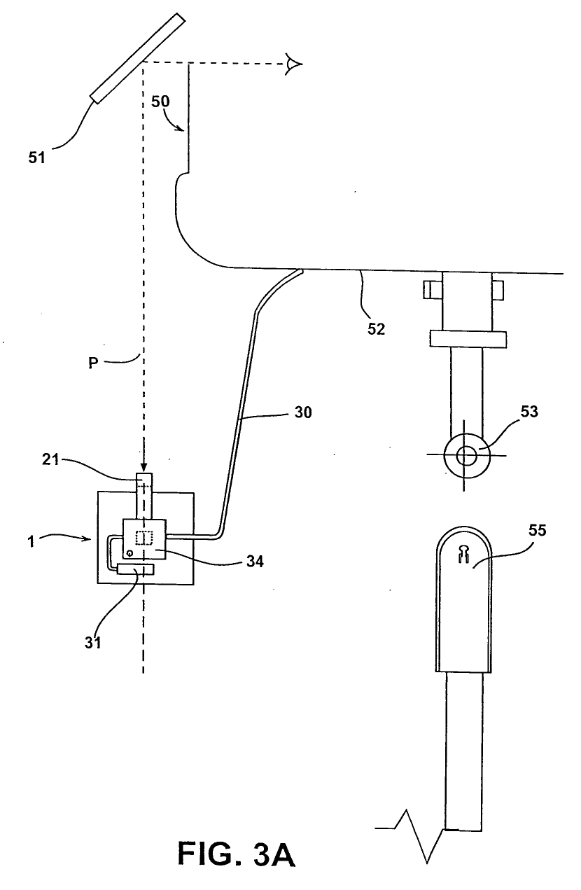

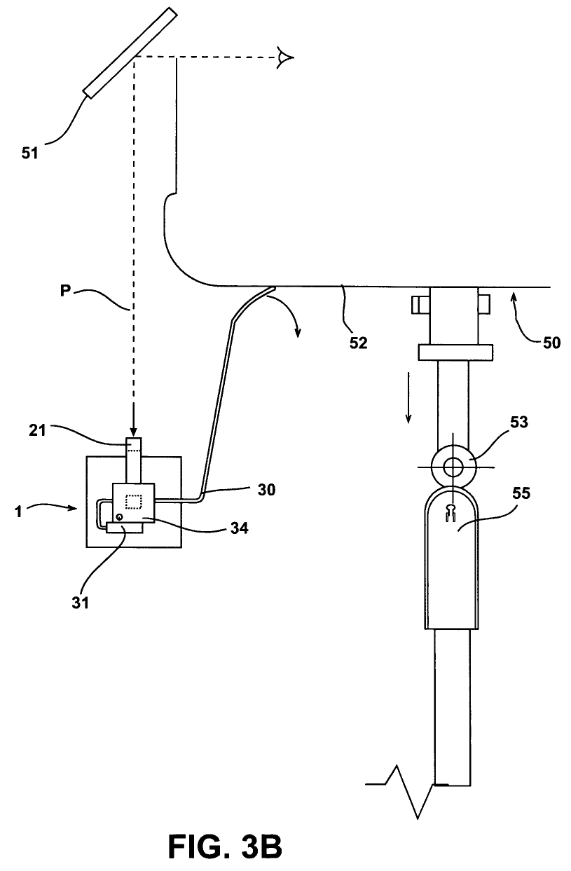

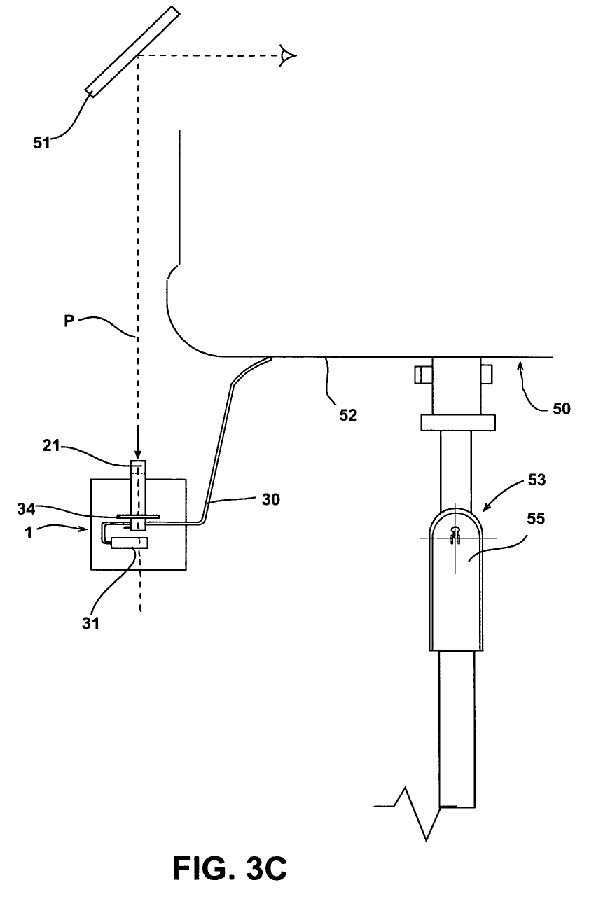

Once hitching aid 1 is positioned, as described above, the driver then enters the vehicle cab and proceeds to back up the vehicle, watching hitching aid 1 in his rear view mirror along sight plane P. The driver steers/maneuvers the towing vehicle backwards toward the trailer, keeping the sight 21 aligned with the target plate 20, which keeps the sight 21 and target plate 20 aligned in the sight plane P of side rearview window 51 of towing vehicle 50. FIGS. 3A, 3B, and 3C illustrate the process of the driver backing up to the trailer. By adjusting the direction of towing vehicle 50 until sight 21 is centered on target plate 20, the driver is lining up towing vehicle 50 with trailer hitch socket 55 as he backs up the towing vehicle.

The driver continues to back up slowly keeping sight 21 centered on target plate 20—i.e., keeping sight 21 and target plate in line with sight plane P. As towing vehicle 50 approaches hitching aid 1, its bumper 52 will come into contact with trigger arm 30. As towing vehicle 50 continues to approach hitching aid 1, bumper 52 pushes rearward the bottom end 30′ of trigger arm 30 rearward and it will pivot, eventually causing trigger roller 31 to abut into signal catch 32. When bumper 52 is nearly backed up to about the transverse plane of the support 41, trigger roller 31 will push signal catch 32 forward (toward the towing vehicle) sufficiently that it will disengage from stop signal 34, releasing stop signal 34. Signal spring 33 will bias stop signal 34 into its up position. The sight of stop signal 34 in its up position, with its broad and preferably bright surface facing the vehicle, signals the driver to stop. Because measuring stick 10 was used to position hitching aid 1 forward of the hitch a distance equal to the distance from bumper 52 to the center of hitch ball 53, hitch ball 53 will now be positioned nearly directly below hitch socket 55—that is, at least within an inch or two. This distance will generally be close enough that the user will be able to lower hitch 55 onto hitch ball 53.

While FIGS. 3A-3C show, for convenience of illustration, the end tip of the trigger arm 30 being contacted by the bumper during the back-up process, the trigger arm 30 is sized so that bumper will typically contact approximately the bottom half of the trigger arm rather than just the tip. When the vehicle bumper first contacts the trigger arm, the bumper typically contacts the trigger arm low on the trigger arm and, as the vehicle backs up, the bumper continues to push on the trigger arm, with the trigger arm sliding along the bumper surface as it pivots. This way, the tip typically does not contact the bumper and so does not become stuck or wedged in the bumper. Trigger arm 30 is preferably designed so that it starts to pivot when the towing vehicle nears the proper hitch position, but also so that it does not pivot to the point at which it actuates the stop signal 34 until the towing vehicle is very nearly in the proper hitching position.

After use, the driver may simply store hitching aid 1 in his vehicle, boat, or RV, or may store hitching aid 1 in its compact form as indicated by the dotted line S in FIG. 1A. In this storage configuration, hitching aid 1 is a relatively short, compact unit that may be stowed away in many locations and/or may be placed in a box or bag for neat and convenience storage. Optionally, a catch or holder may be included to hold the bottom (distal) end 30′ of the trigger arm in place relative to the stand and base during storage. Such a catch may prevent the trigger arm from catching on other items during handling and storage and becoming damaged. One example of such a catch 130 is shown in FIG. 1A on the base 40, wherein the distal tip of the trigger arm may be inserted into the catch 130 during storage in position S.

While the preferred embodiment is shown in the drawings, there are many alterations and options that may be used within the scope of the invention. For example, different sizes and shapes of stand and base may be used, as well as different stop signal systems, different actuation/trigger systems, and/or different measurement systems. Measurement devices that are not attached to the stand may also be used. Also, it should noted that, while the measurements and placements described herein are preferably made accurately, the invented apparatus and methods also work well when the measurements and placements are more roughly made, for example, within about 1-3 inches. The need for accuracy is expected to be greater for larger and heavier towed vehicles, in which cases their hitches are not likely to be easily moved by hand to mate with the towing vehicle hitch. Different measuring systems may be used, preferably within the general approach of placing a stand in a position, preferably relative to the towed vehicle, that is predetermined by the configuration of the towing vehicle. Although this invention has been described above with reference to particular means, materials, and embodiments, it is to be understood that the invention is not limited to these disclosed particulars, but extends instead to all equivalents within the broad scope of the following claims.

1. A hitching aid for use in hitching a towed vehicle to a towing vehicle, the hitching aid comprising:
a stand having a front for generally facing a towing vehicle and a rear;
a signal member movably connected to the stand for signaling a driver of the towing vehicle to stop backing up the towing vehicle toward the towed vehicle;
a trigger member movably extending from the stand and adapted to be pushed rearward by the approaching towing vehicle, so that, when the towing vehicle is at or near a hitching position, the trigger member actuates the signal member to be visible to the driver.

2. A hitching aid as in claim 1, further comprising a catch releasably holding the signal member in a position wherein it is generally non-visible to the driver, and wherein the trigger member pivotally extends from the stand and actuates the signal member by pivoting to release the catch.

3. A hitching aid as in claim 1, wherein the trigger member is an elongated arm extending downward and forward from the stand for being pushed by the bumper of the towing vehicle.

4. A hitching aid as in claim 1, wherein the stand has said front and said rear, and right and left sides, and wherein the hitching aid further comprises a target plate extending right to left on the stand and target member spaced forward from the target plate, wherein the target member appears centered in the target plate when viewed from the front of the stand.

5. A hitching aid as in claim 1, further comprising a measuring string or rope extending from the stand, the string or rope being at least as long as a distance from a hitch of the towing vehicle to a side of the towing vehicle.

6. A hitching aid as in claim 5, further comprising a measuring member connected to an end of said measuring string or rope, said measuring member being a rigid member for extending out perpendicularly from the measuring string or rope.

7. A hitching aid as in claim 1, wherein said signal member is positioned generally horizontally until it is actuated by the trigger member, and, upon said actuation, pivots to generally vertical.

8. A hitching aid as in claim 7, wherein said signal member is generally a plate shape having a color that is different from the color of the stand.

9. A hitching aid as in claim 4, said stand has an upper portion and a lower portion connecting at a central connection, the upper portion comprising the signal member and the target member and target plate, wherein the upper portion is disconnectable from the central connection and reconnectable to the lower portion by connecting the target member to the lower portion so that the overall height of the hitching aid is reduced for storage.

10. A hitching aid as in claim 1, wherein the signal member is not electronic.

11. A hitching aid as in claim 1, wherein the signal member does not comprise a light.

12. A hitching aid system comprising:
a towing vehicle with a rear hitch and a bumper and a vehicle sidewall on a driver's side;
a stand having a signal member and a trigger member adapted to actuate the signal member when the towing vehicle backs up and applies force on the trigger member;
wherein the stand comprises a measurement device for measuring one or more dimensions of the towing vehicle.

13. A hitching aid system as in claim 12, wherein the measurement device comprises a flexible rope or line.

14. A hitching aid system as in claim 12, wherein the measurement device comprises a rigid elongated member pivotally connected to the stand.

15. A hitching aid system as in claim 14, wherein the rigid elongated member is pivotally connected to the stand by a flexible rope or line.

16. A hitching aid system as in claim 14, wherein the rigid elongated member has a length at least as long as the distance between the towing vehicle hitch and the bumper.

17. A hitching aid system as in claim 12, wherein the stand further comprises a catch releasably holding the signal member in an unactuated position wherein it is generally hidden from the driver in the towing vehicle driver's seat, and wherein the trigger member pivotally extends from the stand and actuates the signal member by pivoting to contact and release the catch.

18. A hitching aid system as in claim 12, wherein the trigger member is an elongated arm extending downward and forward from the stand so that it is contacted by the bumper of the towing vehicle.

19. A hitching aid system as in claim 12, wherein the stand has a front and a rear, and right and left sides, and wherein the hitching aid system further comprises a target plate extending right to left on the stand and a target member spaced forward from the target plate, wherein the target member appears centered in the target plate when viewed from the front of the stand.

20. A hitching aid system as in claim 19, wherein the target member is a color different from the color of the target plate, so that the target member contrasts from the target plate.

21. A hitching aid system as in claim 12, wherein the measurement device comprising a measuring string or rope extending from the stand, the string or rope being at least as long as a distance from the hitch of the towing vehicle to the sidewall of the towing vehicle.

22. A hitching aid system as in claim 12, wherein said signal member is positioned generally horizontally until it is actuated by the trigger member, and, upon said actuation, pivots to be generally vertical.

23. A hitching aid system as in claim 21, wherein said signal member is generally a plate shape having a color that is different from the color of the stand.

24. A hitching aid system as in claim 19, wherein said stand has an upper portion and a lower portion connecting at a central connection, the upper portion comprising the signal member and the target member and target plate, wherein the upper portion is disconnectable from the central connection and reconnectable to the lower portion by connecting the target member to the lower portion so that the overall height of the stand is reduced for storage.

25. A hitching aid system as in claim 12, wherein the signal member is not electronic.

26. A hitching aid system as in claim 12, wherein the signal member does not comprise a light.

27. A method of hitching a trailer to a towing vehicle, the method comprising:
measuring a first distance from a hitch to a driver's sidewall of a towing vehicle;
measuring a second distance from the hitch to a bumper surface of the towing vehicle;
placing a stand at a position to one side of a trailer hitch generally equal to said first distance and forward from the trailer hitch of the trailer generally equal to said second distance; and
backing up the towing vehicle while viewing the stand.

28. A method of claim 27, wherein the stand further has a target and a target arm in front of the target, and said backing up the towing vehicle further comprising steering the towing vehicle so that the target arm stays generally centered in said target.

29. A method of claim 28, wherein said backing up the towing vehicle further comprises the bumper contacting and pushing a trigger member on the stand to move rearward.

30. A method of claim 29, further comprising pushing the trigger member with the bumper until the trigger member actuates a stop signal, the method further comprising stopping the towing vehicle upon the driver's seeing the stop signal.
